(19) United States
(12) Patent Application Publication
(10) Pub. No.: US 2025/0327486 A1
(43) Pub. Date: Oct. 23, 2025

(54) MULTIPOD JOINT

(71) Applicants: GKN Driveline International GmbH, Lohmar (DE); GKN Driveline Zumaia SA, Zumaia (ES)

(72) Inventors: Orkan Eryilmaz, Lohmar (DE); Jesús Abenójar García-Minguillán, Zumaia (ES); Daniela Ballas, Lohmar (DE); Arne Berger, Lohmar (DE); Andoni Epelde, Zumaia (ES); David Jaramillo, Zumaia (ES); Julian Lehnert, Lohmar (DE); Patricia Urbistondo, Zumaia (ES); Thomas Weckerling, Lohmar (DE)

(21) Appl. No.: 19/172,476

(22) Filed: Apr. 7, 2025

(30) Foreign Application Priority Data
Apr. 17, 2024 (DE) 102024110829.0

(51) Int. Cl. F16D 3/205; F16D 3/202

(52) U.S. Cl. CPC F16D 3/2055; F16D 2003/2026

(57) ABSTRACT

A multipod joint having an outer joint part with a first longitudinal axis and a cavity which runs parallel to the first longitudinal axis and which has an open end. At least two recesses running parallel to the first longitudinal axis are distributed along a circumferential direction, which extends around the first longitudinal axis. The joint has a joint inner part with a second longitudinal axis, comprising at least one central body on which at least two trunnions are formed with trunnion axes extending radially from the second longitudinal axis. A roller body rotatable at least about the trunnion axis is arranged on each trunnion.

### CROSS REFERENCE TO RELATED APPLICATIONS

This application claims the priority to German Patent Application No. DE102024110829.0 filed on Apr. 17, 2024, and the content of this priority application is incorporated herein by reference in its entirety.

### TECHNICAL FIELD

The present disclosure relates to a multipod joint with an outer joint part and an inner joint part with a central body, which has at least two integrally molded trunnions. A roller body is arranged on each of the trunnions. The disclosure also relates to a motor vehicle with a multipod joint of this type.

### BACKGROUND

The multipod joint is in particular a bipod joint with exactly two trunnions, which are then offset by 180 degrees in particular, and are thus formed on the central body opposite one another. Alternatively, the multipod joint is a tripod joint with exactly three trunnions, which are then formed on the central body offset from one another by 120 degrees in particular. The following explanations apply in particular to all such joint types, taking into account the different number of trunnions.

Tripod joints of this type regularly include, for example, an outer joint part with a first longitudinal axis and a cavity running parallel to the first longitudinal axis, which has an open end, three recesses running parallel to the first longitudinal axis being formed in the outer joint part. The tripod joint also comprises an inner joint part with a second longitudinal axis, comprising at least one central body on which three trunnions are formed with trunnion axes extending radially from the second longitudinal axis. A roller body is arranged on each of the trunnions, which roller body has at least one outer ring and one inner ring rotatable relative to the latter about a common axis of rotation, as well as bearing bodies arranged between the outer ring and the inner ring. Each roller body is accommodated in a recess so as to be movable along the first longitudinal axis.

For the assembly of the multipod joint, the inner joint part can be inserted via the open end into the cavity of the outer joint part with the trunnions and roller bodies arranged thereon.

The central body can itself form a shaft or be connected to a shaft, for example via a spline.

The inner joint part can be displaced along the first longitudinal axis relative to the outer joint part and deflected through a deflection angle relative to the outer joint part. The deflection angle is the smallest angle between the first and the second longitudinal axis. In an extended state of the joint, the deflection angle is zero angular degrees. In a deflected state of the joint, the deflection angle is more than zero angular degrees.

Tripod joints have been manufactured and sold by the applicant for some time, for example under the name AAR tripod joints. They are used in particular in side shafts of motor vehicles, which, for example, serve as the drive connection between a differential gear and the drive wheels. In this case, so-called fixed constant-velocity ball joints are usually used on the wheel side and the AAR tripod joints listed here are used as sliding joints next to the differential gear. The AAR tripod joints are designed in particular for deflection angles of around 23 to 26 degrees (or less).

In the case of a subtype of the AAR tripod joint, the AARi tripod joint, the inner ring is cylindrical towards the trunnion and the inner ring is fixed to the outer ring by means of retaining rings in the direction along the axis of rotation.

The trunnion contacts the bearing bodies or the inner ring of the roller body via so-called sliding surfaces (contact surfaces), which are particularly designed in the shape of a spherical segment. These sliding surfaces are aligned in a circumferential direction around the second longitudinal axis, so that a torque acting around the longitudinal axes of the joint, i.e. in a circumferential direction around the first longitudinal axis, is transmitted via the sliding surfaces of the trunnion to the roller body and from the roller body to the recesses (or vice versa).

A roller body rolls on the raceways provided for it and can thus be displaced in the recess along the first longitudinal axis. Each recess therefore has two raceways lying opposite each other, on which the roller body can be supported in relation to a circumferential direction extending around the first longitudinal axis. Between these raceways of a recess, contact surfaces can be provided, by which the roller body can be supported if necessary.

When operating a motor vehicle, different conditions can occur, for example, on a side shaft, which extends essentially parallel to an axis of a motor vehicle and via which a wheel can be driven by a drive unit. In push-operation (push-mode), the wheel is driven by the drive unit. In pull-operation (pull-mode), the motor vehicle is dragged/pulled by the mass of the motor vehicle that is in motion. For a tripod joint arranged on the side shaft, the contacts between the trunnions and the roller bodies or between the roller bodies and the recesses differ in certain operations/modes.

When the vehicle is moving forward, for example, the direction of rotation of the side shaft is constant. When changing between push- and pull-operation, the contacts between the sliding surfaces of the trunnion and the roller body and between the roller body and the recesses change (i.e. from one side to the other), e.g. viewed in a cross-section perpendicular to the first longitudinal axis and/or the second longitudinal axis. Even when the vehicle changes direction (from forwards to reverse), the contact between the trunnion and the roller body or between the roller body and the recess moves to the other side of the trunnion or recess when viewed in the circumferential direction.

In principle, the side of the sliding surfaces or the recess where the contacts (transmitting the torque) are present is referred to as the ‘active side’ and the other side of the sliding surfaces or the recesses where the contacts are not present is referred to as the ‘passive side’.

When a motor vehicle is in push-mode, i.e. when the motor vehicle is driven by a drive unit, the trunnion makes contact with the roller body via one of the sliding surfaces and the roller body makes contact with one side of the recesses in particular (active side). When the motor vehicle is in push-mode or sailing mode (both also referred to as coasting), i.e. when drive torques are introduced from the wheel and the drive unit is still connected (push-mode) or decoupled (sailing), the trunnion contacts the roller body with the other of the sliding surfaces and the roller body contacts the other side of the recesses (active side). In push-mode or sailing mode, the direction of the applied torques and the direction of rotation of the joint are opposite, whereas in pull-mode they are in the same direction.

The properties of a multipod joint are also defined in particular by a so-called ACFG value (Axial Cyclic Force Generation, unwanted axial forces generated by the joint). This value is given as the root mean square of the force, with the unit Newton root mean square [Nrms]. The value varies depending on the angle of deflection of the joint, whereby the progression of the value depending on the angle of deflection can be defined or determined for each joint. The application range of the joint is thus limited by a maximum deflection angle at which the ACFG value does not exceed an amount still considered permissible.

In addition, for multipod joints, movement of the roller body during operation of the joint must be controlled. For example, the roller body can also contact the recess on the passive side, especially when the joint is operated at an angle of deflection greater than zero angular degrees. This contact can cause noise on the one hand, but on the other hand it can also cause friction losses, whereby abrasion can also occur on the roller body and/or on the recess, which can actually limit the service life of the joint.

To control the movement of the roller body, for example, it is known that the contact surfaces described above can be provided in the recesses, i.e. along the circumferential direction between the raceways of a recess. This can be used to restrict tilting of the roller body (about a so-called tilting or pitch axis-hereinafter also referred to as the first swivel axis). However, the contact between the contact surface and the roller body also generates noise and friction losses. Tilting of the roller body about a so-called rolling axis, which extends transversely to the extension of the respective recess, should also be checked because, in particular, contact between the roller body and the raceway or recess can occur on the passive side.

A tripod joint, for example, is known from the subsequently published DE 10 2023 117 277 A1.

### SUMMARY

The present disclosure is based on the task of at least partially solving the problems described with regard to the prior art. In particular, a multipod joint is to be proposed that can reduce the ACFG forces and prevent contact between the roller body and the recess on a passive side. In addition, contact between the roller body and the contact surfaces of the recess is to be prevented as far as possible.

These tasks are solved with a multipod joint. Further advantageous embodiments are given in the dependent claims. It should be noted that the features individually listed in the dependent claims can be combined with each other in any technologically meaningful way and define further embodiments of the disclosure. Furthermore, the features mentioned in the claims are specified and explained in more detail in the description, where further embodiments of the disclosure are presented.

A multipod joint is proposed, with
an outer joint part with a first longitudinal axis and a cavity running parallel to the first longitudinal axis, the cavity having an open end, wherein at least two (in particular exactly two or exactly three, possibly also more) recesses running parallel to the first longitudinal axis are formed, which are distributed along a circumferential direction, which extends around the first longitudinal axis, and
an inner joint part with a second longitudinal axis, comprising at least one central body, on which at least two (in particular exactly two or exactly three, possibly also more) trunnions are formed with trunnion axes extending radially from the second longitudinal axis, wherein a roller body rotatable at least about the trunnion axis is arranged on each trunnion.
   Each roller body (in particular an outer ring of the roller body) extends annularly around an axis of rotation of the roller body.

Each roller body is movably received in the recesses, movable along the first longitudinal axis. Each recess has two raceways lying opposite one another in the circumferential direction. Each raceway has, along a radial direction, a first segment and a second segment, the radial direction running transverse to the first longitudinal axis. When a torque directed in the circumferential direction is transmitted (during intended operation of the joint), the roller body (in particular the outer ring) is supported against the circumferential direction via a plurality of contact areas on one of the two raceways. In this case, only the contact areas (on the roller body or the outer ring or on the raceway) in the first segment (of the raceway) form an instant center of rotation for the roller body (through a first contact area and a second contact area, and possibly through an additional fourth contact area), while at least one (third) contact area in the second segment only supports the roller body against a rotation around the instant center of rotation.

Alternatively or in addition, this property of the multipod joint can also be described as follows:

Each roller body is movably received in the recesses along the first longitudinal axis. Each recess has two raceways lying opposite each other in the circumferential direction. Each raceway has, along a radial direction, a first segment and a second segment, the radial direction running transversely to the first longitudinal axis. When torque directed in the circumferential direction is transmitted (during intended operation of the joint), the roller body (in particular the outer ring) is supported relative to the circumferential direction via a plurality of contact areas (in particular forming an instant center of rotation) on one of the two raceways. In this case, the roller body contacts the raceway in the first segment via at least two contact areas (either via exactly two or via exactly three contact areas, a first contact area, a second contact area, possibly a fourth contact area) and in the second segment via at least or exactly one (third) contact area (this or these only allow for supporting the roller body against a rotation about the instant center of rotation).

The segments of the raceways are arranged adjacent to one another along a radial direction (or, in the case of an extended arrangement of the joint: along a direction parallel to the axis of rotation or swivel axis). Optionally, a further segment without any special function can also be provided between the segments (e.g. only to space the first segment from the second segment).

Each roller body extends in a ring shape around an axis of rotation of the roller body. Each roller body has a first area and a second area, in particular along the axis of rotation. The areas are arranged adjacent to one another along the axis of rotation. Optionally, another area without a special function can be provided between the areas (e.g. only to space the first area from the second area). The first and second areas are each characterized in particular by a special contour of an outer circumferential surface of the roller body.

In particular, the roller body comprises (exclusively) an outer ring and an inner ring that can rotate relative to each other. In particular, these rings can be in direct contact with each other. Alternatively, bearing bodies (rolling elements, e.g. needle-shaped rolling elements) are additionally arranged between the inner ring and the outer ring. These bearing bodies (in particular of cylindrical design) are arranged in a mounting space of the inner ring or of the outer ring. A multiplicity of these bearing bodies are arranged along the circumferential direction around the axis of rotation. The bearing bodies are secured against displacement along the axis of rotation in particular by means of retaining rings, which are arranged in a respective groove on the outer ring.

The relative rotation of the inner ring in relation to the outer ring allows the roller body to roll along the recesses or raceways in the outer joint part, so that the inner joint part can be displaced along the first longitudinal axis in relation to the outer joint part.

When the inner part of the joint is deflected with respect to the outer part of the joint, the roller bodies continue to be guided by the raceways, with at least the trunnions being pivoted with respect to the roller bodies.

In particular, the roller bodies are guided by the recesses in such a way that it is not possible or is largely restricted to swivel the roller bodies in relation to the recesses (in particular, there is no swivelling about a first swivel axis and/or a second swivel axis).

Alternatively, when the inner part of the joint is deflected, the roller bodies also swivel in relation to the recesses.

In particular, the inner ring and the outer ring can additionally (only) perform a relative displacement along the common axis of rotation to each other, in addition to the relative rotation. In this case, for example, a displacement of the inner ring towards the second longitudinal axis can be limited by a retaining ring, or alternatively no limitation is provided. In particular, a displacement of the inner ring with respect to the outer ring away from the second longitudinal axis is limited by a retaining ring.

In particular, the outer ring and the inner ring form (exactly or only) a first stop, which limits a displacement of the inner ring with respect to the outer ring along the axis of rotation and away from the second longitudinal axis. In particular, this first stop is formed by a projection on the outer ring or on the inner ring, which the inner ring or the outer ring abuts when the inner ring has been maximally displaced. The inner ring can therefore only be displaced along this direction, i.e. along the axis of rotation (in particular away from the second longitudinal axis), until the stop surfaces make contact. In the other direction along the axis of rotation (i.e. towards the second longitudinal axis), the inner ring can be displaced indefinitely, in particular towards the second longitudinal axis, at least with respect to the outer ring, but not with respect to the trunnion.

However, a bipod joint (with only two trunnions) in particular may not have a stop between the outer ring and the inner ring, so that the inner ring can be displaced without limit along the axis of rotation relative to the outer ring.

The starting point or zero point for the displacement is, in particular, the position of the inner ring when the joint is not deflected (i.e. coaxial arrangement of the longitudinal axes of the joint outer part and the joint inner part) starting from the PCR1, i.e. the PCR of the joint inner part. From there, at least the largest part of the movement of the joint inner part (corresponds to the ROM, i.e. the displacement path of the respective trunnion, starting from the PCR1, along the rotational axis away from the second longitudinal axis) is made possible by the possible displacement path up to the first stop. If the inner ring makes contact with the outer ring at the first stop before reaching the maximum angle of deflection, the further movement of the inner part of the joint, in particular up to the maximum angle of deflection, which is (only) reached when the joint is assembled, can be absorbed by the play of the respective roller body in the respective recess on the outer part of the joint.

At least when the axis of rotation and the trunnion axis are arranged coaxially, the inner ring forms a second stop with the trunnion (exactly or only). The second stop limits a displacement of the inner ring along the trunnion axis towards the second longitudinal axis. In the intended operation, when the inner joint part and the outer joint part are arranged together to form the multipod joint, the displacement of the inner ring relative to the trunnion along the pivot axis away from the second longitudinal axis is unlimited, i.e. it is only limited by the first stop. In particular, the outer ring is supported on the recesses, so that the first stop then prevents further displacement of the inner part of the joint.

In particular, the first stop can be used to limit displacement of the inner ring in coasting mode (push-mode and sailing).

In particular, the second stop can be used to control displacement of the inner ring in pull-mode.

In particular, the first stop is arranged along the axis of rotation on a first side of the bearing bodies pointing towards the second longitudinal axis or on a second side of the bearing bodies pointing away from the second longitudinal axis.

If the first stop along the axis of rotation is arranged on a first side of the bearing bodies pointing towards the second longitudinal axis, it can be formed in particular by a projection of the inner ring, which extends along a radial direction away from the axis of rotation and at least partially over (further than) the outer ring.

If the first stop is arranged along the axis of rotation on a second side of the bearing bodies pointing away from the second longitudinal axis, it can be formed in particular by a projection of the outer ring, which extends inwards along a radial direction towards the axis of rotation and at least partially over (further than) the inner ring.

In particular, the first stop is formed by the outer ring itself or by a retaining ring arranged on the outer ring. The retaining ring can, for example, be designed in the manner of a so-called snap ring. The retaining ring can be arranged in a circumferential groove on the outer ring and can project out of the groove so that the retaining ring makes contact with the inner ring when the inner ring is pushed sufficiently far along the axis of rotation and away from the second longitudinal axis.

A snap ring or the groove required for it requires additional space, so that the roller body may have to be larger. On the other hand, the production of the outer ring can be carried out more cost-effectively if a snap ring is provided instead of a projection on the outer ring.

In particular, a mounting space for the bearing bodies on the outer ring is limited by a retaining ring arranged on the outer ring. In particular, the mounting space on both sides of the bearing bodies, i.e. towards the second longitudinal axis on the first side and on the second side facing away from the second longitudinal axis, is limited by a retaining ring in each case.

In particular, the inner ring has a stepped shape in a cross-section (running transversely to the second longitudinal axis), so that a contact surface of the inner ring interacting with the bearing body is arranged offset outwards along the axis of rotation in relation to an end surface of the inner ring (i.e. away from the second longitudinal axis). The end surface of the inner ring is, in particular, the innermost surface (inward along the axis of rotation, i.e. towards the second longitudinal axis) of the inner ring.

The stepped shape may comprise segments that are perpendicular to each other or segments that are inclined to each other.

The retaining ring is in particular of a slotted design so that it is elastically deformable for assembly in the groove of the outer ring.

In particular, the second stop can be formed by a retaining ring that is arranged in a groove on the outer ring.

The intended use of the multipod joint (also referred to as a joint) includes, in particular, that the inner and outer joint parts are arranged in relation to each other as intended for the specific application. For example, all roller bodies are arranged in the recesses and the joint is only operated in a certain range of the deflection angle, e.g. between zero and 30 angular degrees or between zero and 26 angular degrees. Furthermore, the torques considered permissible for the joint are transmitted between the outer and inner joint parts and the rollers only slide along the first longitudinal axis to a certain extent.

Improper (not intended) operation includes, for example, the assembly of the joint or the assembly of joint parts, e.g. the arrangement of the roller bodies on the trunnions.

In particular, each roller body is supported by a plurality of contact areas on (only) one of the two raceways (i.e. on the so-called active side). (At least) three contact areas may be provided.

Each raceway has a first segment and a second segment, in particular along a radial direction, which runs transversely to the first longitudinal axis. The segments are arranged adjacent to one another along the radial direction. Optionally, another segment without a special function can also be provided between the segments (e.g. only to space the first segment from the second segment). The first and second segments are each characterized in particular by a special and different shape of a surface of the raceway. The surface of each raceway is designed to be constant, in particular along the first longitudinal axis (at least in the area that is traversed by the roller bodies during intended operation).

In particular, the contact areas are all located in a cross-section that extends transversely to the first longitudinal axis.

In particular, the contact areas are arranged at a distance from one another along a radial direction that runs perpendicular to the first longitudinal axis.

In particular, only via (i.e. exclusively via) contact areas in the first segment is an instant center of rotation formed for the roller body.

In the first segment, exactly two contact areas (the first contact area and the second contact area) or more than two contact areas can be provided. This further contact area, referred to in the following as the fourth contact area, is then arranged along the radial direction between the first contact area and the second contact area. In particular, the second contact area is arranged along the radial direction between the first contact area and the third contact area (in the second segment).

An instant center of rotation is a well-known abstraction used in kinematics, which is used, for example, in gear technology, robotics and in the design of wheel guides for automobiles.

An instant center of rotation is the point in space around which a rigid body, during a planar movement, can be viewed and treated as rotating only at a particular moment (infinitesimal point in time). The velocity at the instant center of rotation is zero at the moment in question, or would be if the rigid body extended to the instant center of rotation. In particular, the instant center of rotation is formed by the intersection of the surface normal of the first contact area with the surface normal of the second contact area. In particular, a surface normal of a fourth contact area (if present) also extends through the instant center of rotation.

The roller body (or the outer ring of the roller body) makes contact with the raceway in the first segment on the active side via the contact areas (of the first area). The instant center of rotation requires that the contact areas form a pivot joint with a joint axis (the instant center of rotation) around which the roller body or the outer ring can swivel.

In particular, the instant center of rotation is at all times only formed by the contact areas in the first segment. The first and second segments of the respective raceway are specifically defined (based on the raceway's shape and contour) and are therefore fixed, that is cannot be changed. This means in particular that the instant center of rotation is always formed only by the contact areas in the first segment, while the support against rotation about the instant center of rotation is always provided by the contact area in the second segment.

Thus, the position of the contact areas is always defined or determined by the particular design of the raceway.

However, at least one contact area (in particular, exactly one) is provided in the second segment, by which the roller body is supported in such a way that rotation (pivoting) about the instant center of rotation is not possible (i.e. when torque is transmitted and the raceway is in contact on the active side).

In particular, the contact areas are arranged along the trunnion axis and along the radial direction such that, on the active side, support of the roller body or the outer ring against rotation about the instant center of rotation can at all times be provided by the contact area arranged in the second segment, at least during the intended operation of the multipod joint.

In particular, the contact areas of the first segment are used to define or stabilize a position, along the radial direction, of the roller body or the outer ring (with respect to the recess or raceway, i.e. with respect to the outer joint part). In particular, stabilized means that the roller body always returns automatically to this position (in particular due to the applied torque and the contacting surfaces of the roller body and raceway).

In particular, the contact areas of the first segment (also) control a pivoting (a so-called tilting or pitch) of the roller body (or the outer ring) around a first swivel axis (tilting or pitch axis) that runs transversely to the axis of rotation and transversely to the raceways, thus in particular reducing or preventing it. This makes it possible to avoid contact between the roller body or outer ring and the contact surface (in the recess, along the circumferential direction) between the raceways.

In particular, a pivoting (a so-called rolling movement) of the roller body (or the outer ring) about a second swivel axis (rolling axis), which extends transversely to the axis of rotation and parallel to the raceways, is controlled, i.e. in particular reduced or prevented, via the at least one contact area of the second segment. This makes it possible to avoid contact between the roller body or outer ring and the raceway on the passive side.

In particular, the special design of the raceways and roller bodies makes it possible to avoid contact between the roller body and the outer joint part at other (unintended) contact areas (on the otherwise usual contact surfaces or on the passive side). This can be used to reduce or prevent the ACFG value and unwanted noise.

In particular, if the joint is operated as intended and the roller body is not pivoted in the recess (i.e. when the joint is in an extended position), pivoting about the first swivel axis can be limited to an amount of at most 10 angular degrees, in particular no more than 5 angular degrees, which may in some implementations be no more than 3 angular degrees, or no more than 1 angular degree, and which may be no more than 0 (zero) angular degree.

In particular, in the intended operation of the joint and starting from a non-pivoted arrangement of the roller body in the recess (i.e. with the joint in an extended arrangement), pivoting about the second swivel axis can be limited to an amount of at most 5 angular degrees, in particular at most 3 angular degrees, which may be limited to a maximum of 2 angular degrees, which may be limited to a maximum of 1 angular degree, or even completely suppressed (pivoting by zero degrees).

In particular, the roller body (during intended operation of the joint) is supported by exactly three contact areas of the raceway, with only a first contact area and a second contact area, which are arranged in the first segment, forming the instant center of rotation, and with a third contact area, which is arranged in the second segment, only supporting the roller body against the rotation about the instant center of rotation.

In particular, in intended operation of the multipod joint, each roller body contacts the respective recess at any one time only via the majority of the contact areas, which may be only via the first, second and third contact areas (if necessary also via the fourth contact area), on the respective one raceway.

In particular, the raceways and the roller body are designed such that, in the case of an extended arrangement of the multipod joint, i.e. when the longitudinal axes are aligned coaxially with one another (the angle of deflection is then zero angular degrees), the contact areas are arranged at a respective distance from the trunnion axis, wherein the distances differ from one another by at most 10%, in particular at most 5%, which may be at most 2% or even at most 1%, of the smallest distance (and in particular are all the same size). In particular, a (fourth) distance of the fourth contact area, if present, may show a larger deviation. In particular, the (fourth) distance of the fourth contact area is greater than the distances of the other contact areas.

If the distances are as equal as possible, sliding friction between the roller body and the raceway at the contact areas can be minimized (when the roller body rolls along the raceway).

In particular, the raceways and the roller body are designed so that, in an extended arrangement of the multipod joint, i.e. when the longitudinal axes are aligned coaxially with one another, and in a cross-section extending transversely to the longitudinal axes, at each contact area a surface normal to the surface of the roller body has a contact angle between the surface normal and a tangential direction, the tangential direction extending transversely to the trunnion axis and to the longitudinal axis. A contact angle of the (first and second) contact areas forming the instant center of rotation is at least five angular degrees, in particular at least eight angular degrees, which may be at least ten angular degrees. A contact angle of the (first and second) contact areas forming the instant center of rotation may be at most 45 angular degrees, which may be at most 30 angular degrees, or at most 20 angular degrees.

In particular, a fourth contact angle of a fourth contact area, if present, is smaller than the contact angles of the first contact area and the second contact area. In particular, the fourth contact angle is zero degrees.

In particular, the contact angles of the (first and second) contact areas forming the instant center of rotation are equal or different in absolute value. In particular, they differ from one another by one to 10 angular degrees, which may be by one to five angular degrees.

In particular, the first contact angle is greater than the second contact angle, wherein the second contact angle is arranged along the radial direction between the first contact angle and the third contact angle. In particular, the first contact angle is oriented differently than the second contact angle and (if the third contact angle is not equal to zero) the third contact angle. In particular, a sum of the second contact angle and the third contact angle differs from the value of the first contact angle by at most 10 angular degrees, which may be by at most 5 angular degrees, or by at most 2 angular degrees, or in particular corresponds to the value of the first contact angle.

In particular, the contact angle of the (third) contact area, which only supports the roller body against the rotation about the instant center of rotation, is smaller than the contact angles of the (first and second) contact areas forming the instant center of rotation. In particular, the contact angle of this (third) contact area is at most 10 angular degrees, which may be at most 5 angular degrees, or at most 2 angular degrees or even zero angular degrees.

In particular, the contact angle of the (third) contact area, which only supports the rotation of the roller body about the instant center of rotation, is less than one angular degree.

In particular, in the first segment that contacts the contact areas or has the (first and second) contact areas that form the instant center of rotation for the roller body, the raceway has a gothic shape (i.e., it is constructed as a pointed arch made of two circular arcs), in a cross section extending transversely to the first longitudinal axis. If a fourth contact area is provided, it is arranged between the first contact area and the second contact area in the radial direction. The raceway may have a different shape between the pointed arches, for example.

The first contour and the shape of the raceway are designed in particular such that there is a specific relationship between a distance of the (first and second) contact areas in the first segment and a difference of the (first, second and fourth) distances. The relationship is determined by the distance (or its unsigned absolute value, in millimeters), which is parallel to the axis of rotation (with the joint extended), between the first contact area and the second contact area and the difference (or the unsigned amount of it, in millimeters) between the smaller of the first distance (the first contact area) and the second distance (the second contact area) on the one hand and the fourth distance (the fourth contact area) on the other hand.

The following applies to the distance:

$$distance = first contact area - second contact area$$

For the difference, if the first distance is the smaller distance:

$$difference = fourth distance - first distance$$

or, if the second distance is the smaller distance:

$$difference = fourth distance - second distance$$

For the ratio:

$$ratio = distance / difference$$

The ratio is in particular more than 1.5; which may be between 4 and 1.5, or between 2.5 and 1.5.

The circular arcs can in particular have the same or different radii. The (first and second) contact areas between the roller body and raceway then rest on the circular arcs or on the flanks of the pointed arch. Depending on the (first and second) contact angle, the shape of the pointed arch and/or the shape of the circular arcs, the (first and second) contact areas are arranged at an equal distance from the trunnion axis or at a different distance from the trunnion axis.

In particular, the raceway in the second segment contacting the (third) contact area, which only supports the roller body against a rotation about the instant center of rotation, has, in a cross-section, extending transversely of the first longitudinal axis, a rectilinear, concave (i.e. curved away from the roller body) or convex (i.e. curved towards the roller body) form. If the second segments are designed to be straight, the shapes in the cross-section run parallel to each other in particular, also alternatively inclined to each other- and in doing so opening or closing with regard toward the second longitudinal axis. In the case of a parallel arrangement, the shapes in the cross-section (with an extended arrangement of the joint) can also be inclined with respect to the axis of rotation or trunnion axis.

In particular, the roller body has, in a cross-section encompassing the axis of rotation, a first contour of an outer circumferential surface encompassing the (first, second and possibly fourth) contact areas in a first region and a second contour of the outer circumferential surface encompassing the at least one (third) contact area in a second region.

The first contour can be formed by one or more radii or can have a curved shape. For example, the first contour can have a first curvature (defined by at least one radius) at the first contact area and a similar or different second curvature (defined by at least one radius) at the second contact area. In particular, between the curved lines at the contact areas the first contour can also have other lines, including straight lines.

In particular, the first contour is formed by a first radius (that is spherical) and the second contour is formed by a second radius (that is spherical or elliptical). In particular, the radii are different from each other or the same size.

In particular, the second radius is greater than the first radius, in particular by a factor of at least 1.1 or at least 1.2 (i.e. second radius=factor×first radius).

Alternatively, the radii are the same size.

If the radii are the same size, the two raceways of a recess that are contacted by the roller body can be designed differently from one another, so that the arrangement of the first segment and the second segment in the raceways is different.

In particular, a PCR1 of the joint inner part and a PCR2 of the joint outer part are arranged along a radial direction between the instant center of rotation and the at least one third contact area. The respective PCR is the pitch circle radius of the respective joint part.

The definition of the pitch circle radius (also referred to as PCR) is generally known, in particular also for multipod joints.

The pitch circle radius of the trunnions or the inner part of the joint (PCR1) is the so-called effective radius. This is defined with an extended joint, i.e. the longitudinal axes are arranged coaxially to one another. The effective radius defines the lever arm of the resultant force when a torque is transmitted. The pitch circle radius of the trunnion and/or the inner part of the joint is therefore the radius, starting from the second longitudinal axis of the inner part of the joint, on which, for example, the centers of the spherical segment-shaped sliding surfaces of the trunnion are arranged when the joint is extended.

The pitch circle radius of the outer joint part (PCR2) and/or of the recesses is here also referred to as the so-called effective radius, which is defined for an extended joint, i.e. the longitudinal axes are arranged coaxially to one another. The effective radius defines the lever arm of the resultant force when torque is transmitted.

Furthermore, a motor vehicle with at least one multipod joint is also claimed here.

The use of indefinite articles (‘a’, ‘an’) in particular in the claims and the description that reproduces them, is to be understood as such and not as a numeral. Accordingly, terms or components introduced with it are to be understood in such a way that they are present at least once and, in particular, can also be present multiple times.

As a precaution, it should be noted that the number words used here (‘first’, ‘second’, . . . ) primarily serve to distinguish between several similar objects, sizes or processes, and in particular do not necessarily imply any dependency and/or order of these objects, sizes or processes in relation to each other. If a dependency and/or sequence is required, this is explicitly stated here or it is obvious to a person skilled in the art when studying the specifically described design. Insofar as a component can be present multiple times (‘at least one’), the description of one of these components can apply equally to all or some of the majority of these components, but this is not mandatory.

### BRIEF DESCRIPTION OF THE DRAWINGS

The disclosure and the technical environment will be explained in more detail below, with reference to the accompanying figures. It should be noted that the disclosure is not intended to be limited by the cited examples. In particular, the features described with regard to a particular type of joint (bipod joint or tripod joint) can also be applied to other types of joints (i.e. for example to the other of the bipod joint and tripod joint in each case). It should be noted in particular that the figures and in particular the proportions shown are only schematic. Showing:

FIG. 1: a detail of a cross-section of a first design variant of a tripod joint;

FIG. 2: a detail of a cross-section of the first design variant of a tripod joint;

FIG. 3: a second design variant of a tripod joint in a cross-section, in an extended state;

FIG. 4: the tripod joint according to FIG. 3 in a downwardly deflected position;

FIG. 5: the tripod joint according to FIGS. 3 and 4 in an upwardly deflected position;

FIG. 6: the tripod joint according to FIGS. 3 to 5 in a leftwardly deflected position;

FIG. 7: the tripod joint according to FIGS. 3 to 6 in a position deflected to the right;

FIG. 8: a detail of a cross-section of a third design variant of a tripod joint;

FIG. 9: a detail of a cross-section of a fourth design variant of a tripod joint;

FIG. 10: a detail of a cross-section of a fifth design variant of a tripod joint;

FIG. 11: the detail of the first design variant of a tripod joint according to FIG. 2;

FIG. 12: a detail of a cross-section of a sixth design variant of a tripod joint;

FIG. 13: a detail of a cross-section of a seventh design variant of a tripod joint;

FIG. 14: a detail of a cross-section of an eighth design variant of a tripod joint;

FIG. 15: a detail of a cross-section of a ninth design variant of a tripod joint;

FIG. 16: a detail of a cross-section of a tenth design variant of a tripod joint;

FIG. 17: a detail of a cross-section of an eleventh design variant of a tripod joint;

FIG. 18: a detail of a cross-section of a twelfth design variant of a tripod joint;

FIG. 19: a detail of a cross-section of a thirteenth design variant of a tripod joint;

FIG. 20: a detail of a cross-section of a fourteenth design variant of a tripod joint;

FIG. 21: a detail of a cross-section of a fifteenth design variant of a tripod joint;

FIG. 22: a detail of a cross-section of a sixteenth embodiment of a tripod joint;

FIG. 23: a detail of a cross-section of a seventeenth embodiment of a tripod joint;

FIG. 24: a detail of a cross-section of a bipod joint;

FIG. 25: the tripod joint according to the second embodiment in an extended state in a side view in section; and

FIG. 26: the tripod joint according to FIG. 25 in a deflected state.

### DETAILED DESCRIPTION

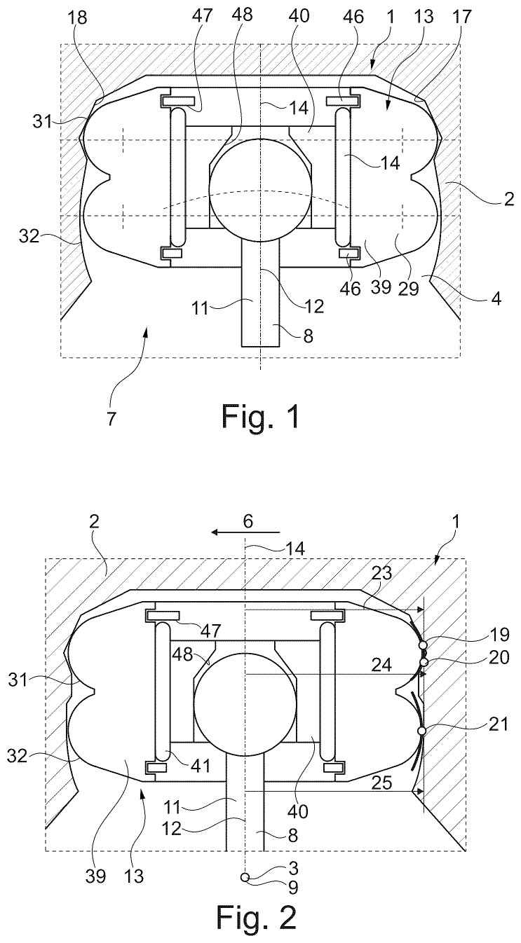

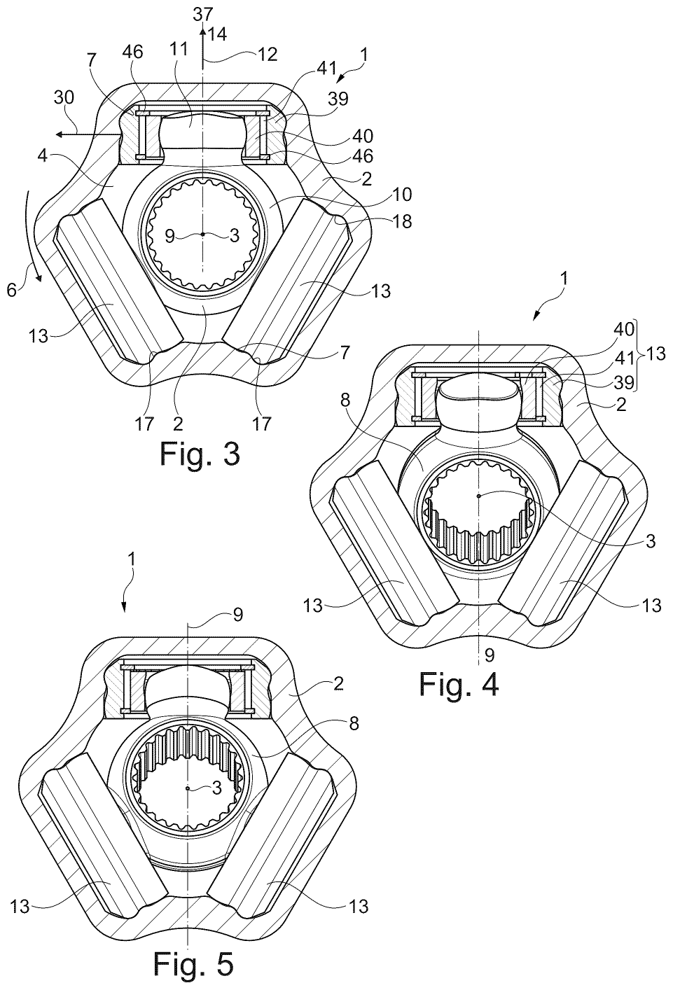

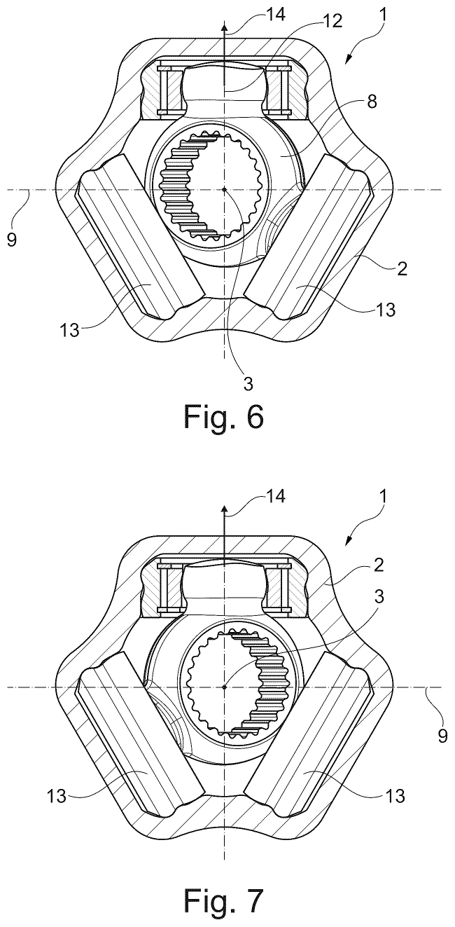

FIG. 1 shows a detail of a cross-section of a first design variant of a tripod joint 1. FIG. 2 shows a detail of a cross-section of the first design variant of a tripod joint 1. FIG. 3 shows a second design variant of a tripod joint 1 in a cross-section, in an extended state. FIG. 4 shows the tripod joint 1 according to FIG. 3 in a downwardly deflected position. FIG. 5 shows the tripod joint 1 according to FIGS. 3 and 4 in an upwardly deflected position. FIG. 6 shows the tripod joint 1 according to FIGS. 3 to 5 in a leftwardly deflected position. FIG. 7 shows the tripod joint 1 according to FIGS. 3 to 6 in a position deflected to the right. The FIGS. 1 to 7 are described together in the following.

The tripod joint 1 comprises an outer joint part 2 having a first longitudinal axis 3 and a cavity 4 which extends parallel to the first longitudinal axis 3 and which has an open end 5, wherein three recesses 7 extending parallel to the first longitudinal axis 3 are formed in a distributed manner in the outer joint part 2 along a circumferential direction 6, which extends around the first longitudinal axis 3. The tripod joint 1 further comprises an inner joint part 8 having a second longitudinal axis 9. The inner joint part 8 comprises a central body 10 on which three trunnions 11 are formed, having trunnion axes 12 extending radially from the second longitudinal axis 9, wherein a roller body 13 rotatable at least about the trunnion axis 12 is arranged.

Each roller body 13 extends annularly around a rotational axis 14 of the roller body 13.

Each roller body 13 is movably received in a recess 7, movably along the first longitudinal axis 3. Each recess 7 has two raceways 17, 18 located opposite one another in the circumferential direction 6. Each raceway 17, 18 has a first segment 15 and a second segment 16 along a radial direction 37, the radial direction 37 running transversely to the first longitudinal axis 3. When transmitting a torque directed in the circumferential direction 6, the roller body 13 is supported with the outer ring 39 against the circumferential direction 6 via a plurality of contact areas 19, 20, 21, which are arranged on one of the two raceways 17, 18. In this case, only contact areas 19, 20 (on one of the raceways 17, 18) in the first segment 15 form an instant center of rotation 22 for the roller body 13, and at least one contact area 21 in the second segment 16 only supports the roller body 13 against a rotation about the instant center of rotation 22.

Each roller body 13 extends annularly around an axis of rotation 14 of the roller body 13. Each roller body 13 has a first region 44 and a second region 45 along the axis of rotation 14. The regions 44, 45 are arranged adjacent to one another along the axis of rotation 14. Between the regions 44, 45, a further area without any special function is provided (e.g. only for spacing the first region 44 from the second region 45 or for forming the transition between the regions 44, 45). The first region 44 and the second region 45 are each characterized by a special contour 31, 32 of an outer circumferential surface of the roller body 13.

The roller body 13 comprises an outer ring 39 and an inner ring 40, which can rotate relative to each other. For this purpose, bearing bodies (rolling elements, here needle-shaped rolling elements) are arranged between the inner ring 40 and the outer ring 39. These bearing bodies 41 are arranged in a mounting space of the outer ring 39, the mounting space being limited with respect to the direction of the axis of rotation 14 by retaining rings 46. A plurality of these bearing bodies 41 are arranged around the axis of rotation 14 in the circumferential direction 6. The bearing bodies 41 are secured against displacement along the axis of rotation 14 by the retaining rings 46, which are arranged in a respective groove on the outer ring 39.

The rotation of the inner ring 40 with respect to the outer ring 39 allows the roller body 13 to roll along the recesses 7 or raceways 17, 18 in the joint outer part 2, so that the joint inner part 8 can be displaced along the first longitudinal axis 3 with respect to the joint outer part 2.

When the inner part of the joint 8 is deflected with respect to the outer part of the joint 2, the roller bodies 13 continue to be guided by the raceways 17, 18, with at least the trunnions 11 being pivoted/swivelled with respect to the roller bodies 13.

In this case, the roller bodies 13 are guided by the recesses 7 in such a way that it is not or only hardly possible to pivot/swivel the roller bodies 13 with respect to the recesses 7.

In addition to the relative rotation, the inner ring 40 and the outer ring 39 can also perform a relative displacement along the common axis of rotation 14 with respect to each other. In this case, a displacement of the inner ring 40 towards the second longitudinal axis 9, for example, can be limited by a retaining ring 46 (see, for example, FIG. 8), or alternatively no limitation is provided (see, for example, FIGS. 1 to 7). A displacement of the inner ring 40 relative to the outer ring 39 away from the second longitudinal axis 9 is limited by a retaining ring 46.

The outer ring 39 and the inner ring 40 form (exactly or only) a first stop 47 via the retaining ring 46, which limits a displacement of the inner ring 40 with respect to the outer ring 39 along the axis of rotation 14 and away from the second longitudinal axis 9. This first stop 47 is formed by a projection (the retaining ring 46) on the outer ring 39, which the inner ring 40 abuts when the inner ring 40 has been pushed as far away as possible from the second longitudinal axis 9. The inner ring 40 can therefore only be displaced along this direction, i.e. along the axis of rotation 14 (away from the second longitudinal axis 9), until the stop surfaces make contact. In the other direction along the rotational axis 14 (i.e. towards the second longitudinal axis 9), the inner ring 40 can be displaced without limit in the intended operation, at least with respect to the outer ring 39, but not with respect to the trunnion 11.

The starting point or zero point for the displacement is the position of the inner ring 40 with the joint 1 being not deflected (i.e. coaxial arrangement of the longitudinal axes 3, 9 of the joint outer part 2 and the joint inner part 8, see FIG. 3), starting from the PCR1 35, i.e. the PCR of the joint inner part 8. From there, at least the largest part of the movement of the joint inner part 8 (corresponds to the ROM, i.e. the displacement path of the respective trunnion 11 starting from the PCR1 35 along the axis of rotation 14 away from the second longitudinal axis 9) is made possible by the possible displacement path towards the first stop 47. If the inner ring 40 contacts the outer ring 39 at the first stop 47 before reaching the maximum deflection angle 52, the further movement of the inner part of the joint 8, in particular up to the maximum deflection angle 52, which is (only) reached when the joint 1 is assembled, can be absorbed by the play of the respective roller body 13 in the respective recess 7 on the joint outer part 2.

At least when the rotational axis 14 and the trunnion axis 12 are arranged coaxially, the inner ring 40 forms (exactly or only) a second stop 48 with the trunnion 11. The second stop 48 limits a displacement of the inner ring 40 along the trunnion axis 12 towards the second longitudinal axis 9. In the intended operation, when the inner joint part 8 is arranged together with the outer joint part 2 to form the tripod joint 1, the displacement of the inner ring 40 with respect to the trunnion 11, along the trunnion axis 12 away from the second longitudinal axis 9, is unrestricted, i.e. it is only restricted by the first stop 47. In this case, the outer ring 39 is supported on the recesses 7 or the raceways 17, 18, so that the first stop 47 then prevents any further displacement of the inner part of the joint 8.

The first stop 47 can be used to limit displacement of the inner ring 40 in coasting operation (push-mode and sailing).

The second stop 48 can be used to control displacement of the inner ring 40 in pull-mode.

The first stop 47 is arranged along the axis of rotation 14 on a second side of the bearing body 41 pointing away from the second longitudinal axis 9.

The first stop 47 is formed by a retaining ring 46 arranged on the outer ring 39. The retaining ring 46 is designed in the manner of a so-called snap ring. The retaining ring 46 is arranged in a circumferential groove on the outer ring 39 and protrudes out of the groove so that the retaining ring 46 makes contact with the inner ring 40 when the inner ring is pushed sufficiently far along the rotational axis 14 and away from the second longitudinal axis 9.

The mounting space for the bearing bodies 41 on the outer ring 39 is limited by a retaining ring 46 arranged on the outer ring 39. The mounting space is limited on both sides of the bearing body 41, i.e. towards the second longitudinal axis 9 on the first side and on the second side facing away from the second longitudinal axis 9, by a respective retaining ring 46.

Each roller body 13 is supported by a plurality of contact areas 19, 20, 21 on one of the two raceways 17, 18 (i.e. on the so-called active side). There are three contact areas 19, 20, 21.

Each raceway 17, 18 has a first segment 15 and a second segment 16 along a radial direction 37 that extends transversely to the first longitudinal axis 3. The segments 15, 16 are arranged adjacent to one another along the radial direction 37. A further segment without any special function is provided between the segments 15, 16 (e.g. only to space the first segment 15 from the second segment 16 or to form the transition between the segments 15, 16). The first segment 15 and the second segment 16 are each characterized by a special form of a surface of the raceway 17, 18. The surface of each raceway 17, 18 is designed to be constant along the first longitudinal axis 3 (at least in the area over which the roller bodies 13 move during intended operation).

The contact areas 19, 20, 21 all lie in a cross-section that runs transversely to the first longitudinal axis 3. The contact areas 19, 20, 21 are arranged at a distance from one another along the radial direction 37, which runs transversely to the first longitudinal axis 3. An instant center of rotation 22 for the roller body 13 is formed only via (i.e. exclusively via) contact areas 19, 20 in the first segment 15. The instant center of rotation 22 is formed by the point of intersection of the surface normal 26 of the first contact area 19 with the surface normal 26 of the second contact area 20.

In the case of a planar movement of a rigid body (here the roller body 13 or the outer ring 39), an instant center of rotation 22 is that point in space around which the body can be viewed and treated as only rotating at one moment (point in time, infinitesimal) (because it is pressed against the contour of the raceway 17, 18) due to the torque. The speed at the instant center of rotation is zero at the moment in question.

The roller body 13 (or the outer ring 39 of the roller body 13) makes contact on the active side via the contact areas 19, 20 (of the first region 44) with the first raceway 17 in the first segment 15. The instant center of rotation 22 requires that the contact areas 19, 20 form a pivot joint with a joint axis (the instant center of rotation 22), about which the roller body 13 or the outer ring 39 can or would pivot.

However, exactly one third contact area 21 is provided in the second segment 16, on which the roller body 13 is supported in such a way that it is not possible to rotate (swing) around the instant center of rotation 22.

The instant center of rotation 22 is only formed by the contact areas 19, 20 in the first segment 15 at any given time. The first segment 15 and the second segment 16 of the respective raceway 17, 18 are fixed, i.e. the are unchangeable. This means that the instant center of rotation 22 is always formed only by the contact areas 19, 20 in the first segment 15, while the rotation around the instant center of rotation 22 is always inhibited by the third contact area 21 in the second segment 16.

This means that the position of the contact areas 19, 20, 21 is always defined or determined by the particular design of the raceway 17, 18.

The contact areas 19, 20, 21 are arranged along the trunnion axis 12 or along the radial direction 37 such that, on the active side, the third contact area 21 arranged in the second segment 16 always provides for the support of the roller body 13 or of the outer ring 39 against a rotation about the instant center of rotation 22, at least during the intended operation of the tripod joint 1.

A position of the roller body 13 or of the outer ring 39 along the radial direction 37 (relative to the recess 7 or the raceway 17, 18, i.e. relative to the outer joint part 2) is therefore defined or stabilized via the contact areas 19, 20 of the first segment 15. Stabilized means that the roller body 13 always automatically returns to this position (due to the form/shape of the first segment 15, the respective region 44, 45 and the prevailing torque that is transmitted between the outer joint part 2 and the inner joint part 8).

The contact areas 19, 20 of the first segment 15 also control a swivelling/pivoting of the roller body 13 (or the outer ring 39) about a first swivel axis 42, which runs transversely to the axis of rotation 14 and transversely to the raceways 17, 18, and thus in particular reduce or prevent it. This means that contact between the roller body 13 or outer ring 39 and the contact surface of the joint outer part 2 (in the recess 7, along the circumferential direction 6 between the raceways 17, 18) can be avoided.

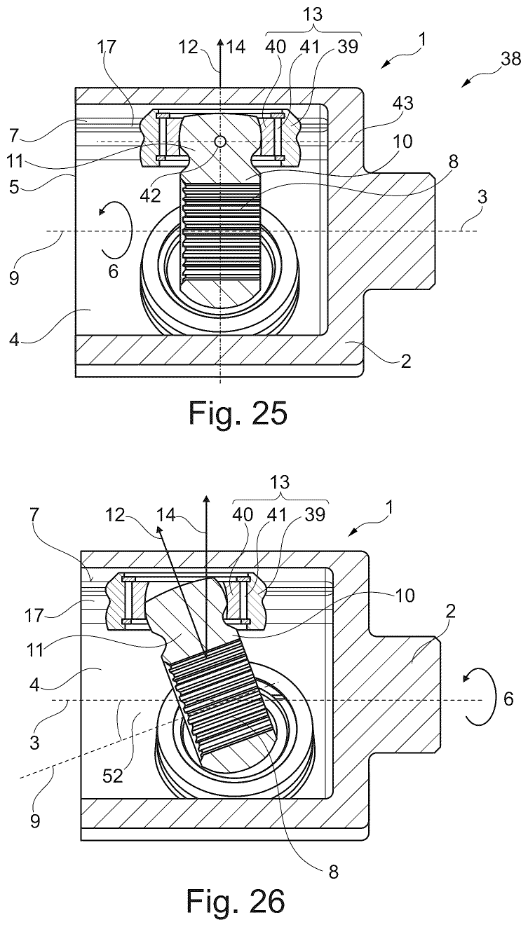

The third contact area 21 of the second segment 16 is used to control a swivelling/pivoting of the roller body 13 (or the outer ring 39) about a second swivel axis 43, which runs transversely to the axis of rotation 14 and parallel to the raceways 17, 18 (see FIGS. 25 and 26), i.e. in particular to reduce or prevent it. This avoids contact between the roller body 13 or outer ring 39 and the raceway 17, 18 on the passive side.

The special design of raceways 17, 18 and roller bodies 13 or outer ring 39 can prevent contact between roller body 13 and outer joint part 2 at other (unintended) contact areas (at the otherwise usual contact surfaces or on the passive side). This means that the ACFG value can also be used to reduce or prevent unwanted noise.

The roller body 13 is supported (during intended operation of the joint 1) via exactly three contact areas 19, 20, 21 of the respective contacted raceway 17, 18 (i.e. only on the active side), whereby the instant center of rotation 22 is formed only by a first contact area 19 and a second contact area 20, which are arranged in the first segment 15, and a third contact area 21, which is arranged in the second segment 16, only supports the roller body 13 against the rotation about the instant center of rotation 22.

In intended operation of the tripod joint 1, each roller body 13 contacts the respective recess 7 at any one time only via the majority of the contact areas 19, 20, 21, that is to say only via the first contact area 19, the second contact area 20 and the third contact area 21, at the respective one raceway 17, 18.

The raceways 17, 18 and the roller body 13 are designed such that, in the case of an extended arrangement of the tripod joint 1 (see FIGS. 2, 3, 26), i.e. when the longitudinal axes 3, 9 are aligned coaxially with one another (the angle of inclination 52 then amounts to zero angular degree), the contact areas 19, 20, 21 are arranged at a respective distance (first distance 23, second distance 24, third distance 25) from the trunnion axis 12, wherein the distances 23, 24, 25 differ from one another by at most 1% of the greatest distance 23, 24, 25.

If the distances 23, 24, 25 are of equal size, sliding friction between the roller body 13 and raceway 17, 18 can be minimized at the contact areas 19, 20, 21 (when the roller body 13 rolls on the raceway 17, 18).

The raceways 17, 18 and the roller body 13 are designed in such a way that—with an extended arrangement of the tripod joint 1, i.e. when the longitudinal axes 3, 9 are aligned coaxially with one another, and in a cross-section extending transversely to the longitudinal axes 3, 9—at each contact area 19, 20, 21 a surface normal 26 to the surface of the roller body 13 has a contact angle (first contact angle 27, second contact angle 28, third contact angle 29) between the surface normal 26 and a tangential direction 30, which extends transversely to the trunnion axis 12 and to the longitudinal axis 3, 9. A contact angle 27, 28 of the contact areas 19, 20 forming the instant center of rotation 22 is approximately 10 angular degrees in each case.

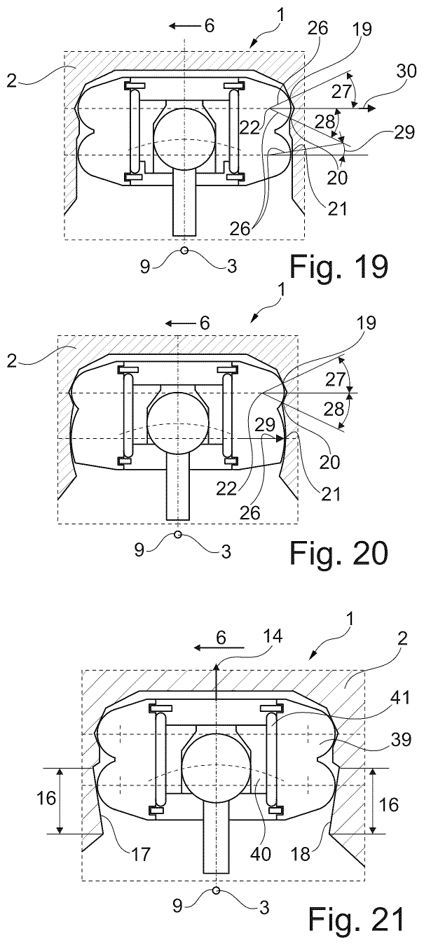

The contact angles 27, 28 of the contact areas forming the instant center of rotation 22 are respectively equal in absolute value (see FIGS. 1 and 2) or different in absolute value (e.g. FIGS. 19 and 20).

The third contact angle 29 of the third contact area 21, which only supports the roller body 13 against rotation about the instant center of rotation 22, is smaller than the contact angles 27, 28 of the contact areas 19, 20 forming the instant center of rotation 22. The third contact angle 29 of this third contact area 21 is zero angular degrees (see FIGS. 1 to 7). However, it can also be approx. 5 angular degrees (see FIGS. 19, 21, 22).

The raceway 17, 18 has, in the first segment 15, which contacts the contact areas 19, 20 or has the contact areas 19, 20, which form the instant center of rotation 22 for the roller body 13, in a cross-section extending transversely to the first longitudinal axis 3, a Gothic shape (i.e. it is constructed as a pointed arch from two circular arcs, see, for example, FIGS. 3 to 7). In this case, the circular arcs can also have such a large radius, or even be infinite, that a conical shape is obtained (see, for example, FIGS. 1 and 2).

The circular arcs can have the same or different radii. The contact areas 19, 20 between the roller body 13 and raceway 17, 18 are in contact with the circular arcs or the flanks of the pointed arc. Depending on the contact angle 27, 28 or the shape of the pointed arch or the shape of the circular arcs, the contact areas 19, 20 are arranged at an equal distance 23, 24 from the trunnion axis 12 or at a different distance 23, 24 from the trunnion axis 12.

In the second segment 16, which makes contact with the third contact area 21, which only supports the roller body 13 against the rotation about the instant center of rotation 22, the raceway 17, 18 has, in a cross-section extending transversely to the first longitudinal axis 3, a straight (FIGS. 3 to 7), concave (i.e. curved away from the roller body 13; see FIGS. 1 and 2) or convex (i.e. curved towards the roller body 13; see FIG. 13) shape. If the second segments 16 are straight, the shapes in the cross-section run parallel to each other (see FIGS. 3 to 7 and 22), or alternatively inclined to each other, opening (see FIG. 19) or closing (see FIG. 21) towards the second longitudinal axis 9.

In a cross-section encompassing the axis of rotation 14, the roller body 13 has, in a first region 44, a first contour 31 of an outer circumferential surface encompassing the contact areas 19, 20, and, in a second region 45, a second contour 32 of the outer circumferential surface encompassing at least a third contact area 21. The first contour 31 is formed by a first radius 33 (i.e. spherical) and the second contour 32 by a second radius 34 (i.e. spherical—e.g. FIGS. 1 to 7—or elliptical—e.g. FIGS. 3 to 7 and 20). In particular, the radii 33, 34 are different from each other or the same size.

If the radii 33, 34 are different, the second radius 34 is greater than the first radius 33 (see FIGS. 3, 7 and 20).

Alternatively, the radii 33, 34 are the same size (FIGS. 1 and 2).

If the radii 33, 34 are the same size, the two raceways 17, 18 of a recess 7, which are contacted by the roller body 13, can be designed differently from one another, so that the arrangement of the first segment 15 and the second segment 16 in the raceways 17, 18 is different (see, for example, FIG. 17).

A PCR1 35 of the inner joint part 8 and a PCR2 36 of the outer joint part 2 are arranged along a radial direction 37 between the instant center of rotation 22 and the at least one third contact area 21.

FIG. 8 shows a detail of a cross-section of a third design variant of a tripod joint 1. Reference is made to the explanations relating to FIGS. 1 to 7.

Here the trunnion 11 is spherical and the inner ring 40 is cylindrical. The inner ring 40 is arranged on the outer ring 39 so as to be fixed in view of both directions along the axis of rotation 14 by means of the retaining rings 46 arranged in the outer ring 39.

In a cross-section encompassing the axis of rotation 14, the roller body 13 has, in a first region 44, a first contour 31 of an outer circumferential surface encompassing the contact areas 19, 20, and, in a second region 45, a second contour 32 of the outer circumferential surface encompassing at least one third contact area 21. The first contour 31 is formed by a first radius 33 (that is spherical) and the second contour 32 by a second radius 34 (that is spherical), the radii 33, 34 being equal in size.

The raceway 17, 18 has, in the first segment 15, which makes contact with the contact areas 19, 20 or has the contact areas 19, 20 that form the instant center of rotation 22 for the roller body 13, a Gothic shape, in a cross-section extending transversely to the first longitudinal axis 3. The circular arcs have identical radii 33, 34. The contact areas 19, 20 between the roller body 13 and the raceway 17, 18 are in contact with the circular arcs or the flanks of the pointed arch.

The raceway 17, 18 has, in the second segment 16, which makes contact with the third contact area 21, which only supports the roller body 13 against the rotation about the instant center of rotation 22, a rectilinear shape, in a cross-section extending transversely to the first longitudinal axis 3, whereas the shapes in the cross-section being parallel to one another.

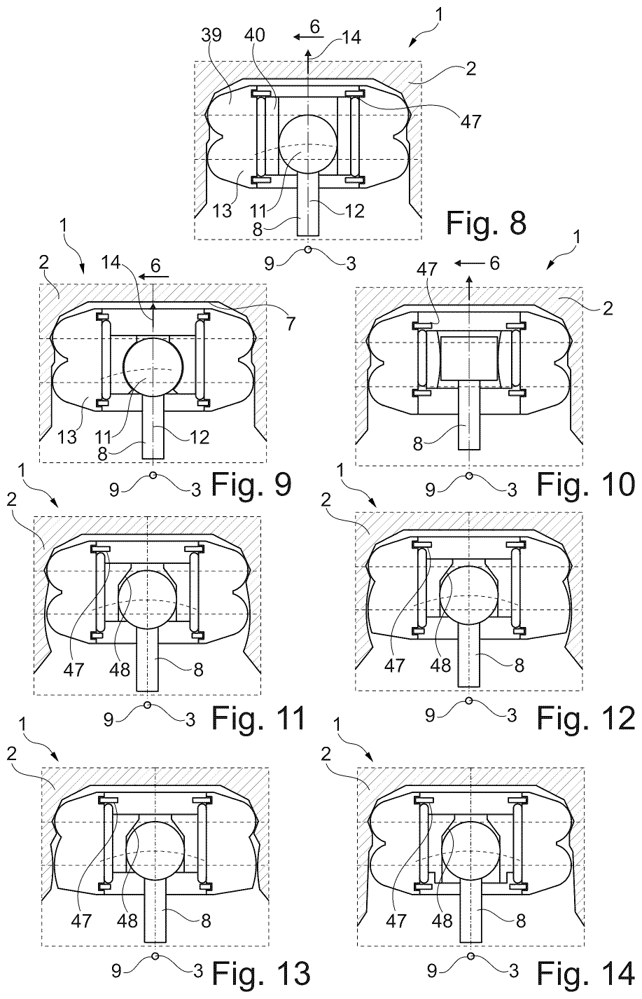

FIG. 9 shows a detail of a cross-section of a fourth design variant of a tripod joint 1. Reference is made to the explanations relating to FIG. 8.

In contrast to the third design variant, the inner ring 40 has a concave spherical sliding surface towards the trunnion 11. The inner ring 40 can slide freely along the axis of rotation 14 in relation to the outer ring 39.

FIG. 10 shows a detail of a cross-section of a fifth design variant of a tripod joint 1. Reference is made to the explanations relating to FIG. 8.

In contrast to the third design variant, the inner ring 40 has a convex sliding surface towards the trunnion 11, whereby the trunnion is cylindrical.

A displacement of the inner ring 40 relative to the outer ring 39 away from and towards the second longitudinal axis 9 is limited by a respective retaining ring 46. The first stop 47 formed by the retaining ring 46 is arranged along the axis of rotation 14 on a second side of the bearing body 41 pointing away from the second longitudinal axis 9.

FIG. 11 shows a detail of the first design variant of a tripod joint 1 according to FIGS. 1 and 2. Reference is made to the explanations regarding FIGS. 1 to 7.

FIG. 12 shows a detail of a cross-section of a sixth design variant of a tripod joint 1. Reference is made to the explanations regarding FIG. 11.

In contrast to the first design variant, the roller body 13 has, in a cross-section that encompasses the axis of rotation 14, in a second region 45 a second contour 32 of the outer circumferential surface that encompasses the at least one third contact area 21, wherein this second contour 32 is elliptically shaped.

FIG. 13 shows a detail of a cross-section of a seventh design variant of a tripod joint 1. Reference is made to the explanations regarding FIG. 12.

In contrast to the sixth design variant, the raceway 17, 18 has in the second segment 16, which contacts the third contact area 21, which only supports the roller body 13 against the rotation about the instant center of rotation 22, in a cross-section extending transversely to the first longitudinal axis 3, a convex (i.e. curved towards the roller body 13) shape.

FIG. 14 shows a detail of a cross-section of an eighth design variant of a tripod joint 1. Reference is made to the explanations relating to FIGS. 1 to 7.

In contrast to the first design variant, the raceway 17, 18 has in the second segment 16, which contacts the third contact area 21, which only supports the roller body 13 against the rotation about the instant center of rotation 22, in a cross-section extending transversely to the first longitudinal axis 3, a rectilinear shape. The shapes in the cross-section are inclined to one another—and thus open towards the second longitudinal axis 9.

In contrast to the first design variant, the inner ring 40 has a stepped shape in a cross-section running transversely to the second longitudinal axis 9, so that a contact surface of the inner ring 40 interacting with the bearing bodies 41 is arranged, in relation to an end surface of the inner ring 40, offset outwards along the axis of rotation 14 (i.e. away from the second longitudinal axis 9). The end face of the inner ring 40 is the innermost face of the inner ring 40 (innermost along the axis of rotation 14, i.e. towards the second longitudinal axis 9). The stepped shape comprises segments that are perpendicular to one another. In addition, the inner ring 40 is arranged on the outer ring 39 so as to be fixed against both directions along the axis of rotation 14 by means of the retaining rings 46 arranged in the outer ring 39.

As a result of the stepped shape, the inner ring 40 can be pushed further along the axis of rotation 14 towards the second longitudinal axis 9.

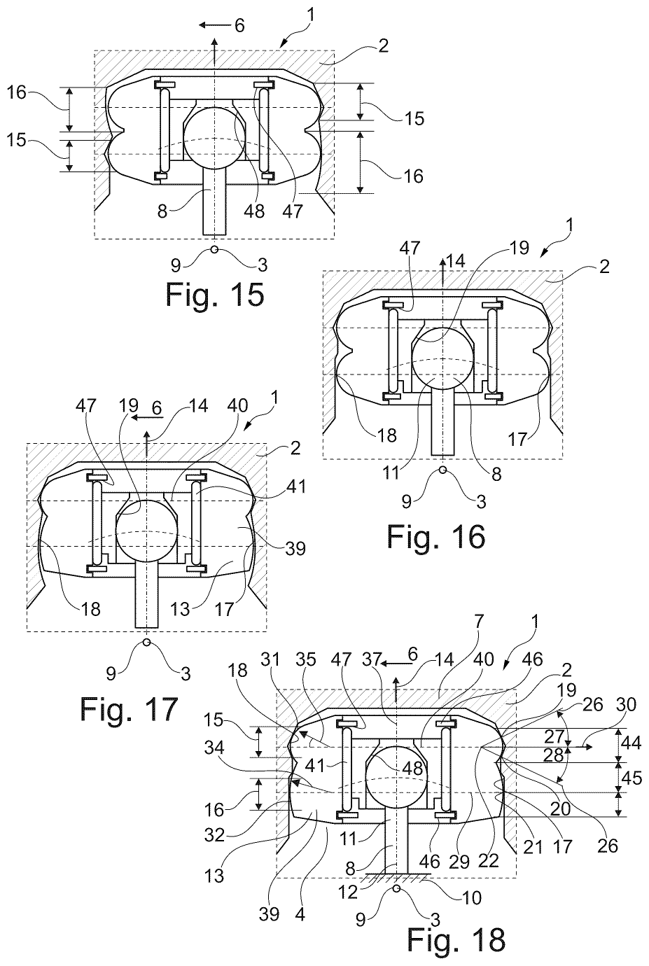

FIG. 15 shows a detail of a cross-section of a ninth design variant of a tripod joint 1. Reference is made to the explanations relating to FIGS. 3 to 7.

In contrast to the second embodiment, the raceways 17, 18 of a recess 7, which are contacted by the roller body 13, are designed differently from one another, so that the arrangement of the first segment 15 and the second segment 16 in the raceways 17, 18 is different or interchanged.

FIG. 16 shows a detail of a cross-section of a tenth design variant of a tripod joint 1. Reference is made to the explanations regarding FIG. 14.

In contrast to the eighth design variant, the raceway 17, 18 has in the second segment 16, which contacts the third contact area 21, which only supports the roller body 13 against the rotation about the instant center of rotation 22, in a cross-section extending transversely to the first longitudinal axis 3, a rectilinear shape, the shapes being parallel to one another.

FIG. 17 shows a detail of a cross-section of an eleventh design variant of a tripod joint 1. Reference is made to the explanations regarding FIG. 16.

In contrast to the tenth design variant, the raceway 17, 18 has in the second segment 16, which contacts the third contact area 21, which only supports the roller body 13 against the rotation about the instant center of rotation 22, in a cross-section extending transversely to the first longitudinal axis 3, a concave shape (i.e. a shape curved away from the roller body 13).

In contrast to the tenth embodiment, the roller body 13 has, in a cross-section that encompasses the axis of rotation 14, in a second region 45 a second contour 32 of the outer circumferential surface, encompassing the at least a third contact area 21, wherein the second contour 32 is elliptically shaped.

FIG. 18 shows a detail of a cross-section of a twelfth design variant of a tripod joint 1. Reference is made to the explanations regarding FIG. 17.

In contrast to the eleventh embodiment, the raceway 17, 18 has in the second segment 16, which contacts the third contact area 21, which only supports the roller body 13 against the rotation about the instant center of rotation 22, in a cross-section extending transversely to the first longitudinal axis 3, a straight/rectilinear shape, the shapes of the raceways 17, 18 running parallel to one another.

FIG. 19 shows a detail of a cross-section of a thirteenth design variant of a tripod joint 1. Reference is made to the explanations relating to FIG. 16.

In contrast to the tenth embodiment, the raceway 17, 18 has in the second segment 16, which contacts the third contact area 21, which only supports the roller body 13 against the rotation about the instant center of rotation 22, in a cross-section extending transversely to the first longitudinal axis 3, a rectilinear shape. The shapes in the cross-section are inclined to one another—and thus open towards the second longitudinal axis 9.

In addition, the contact angles 27, 28 of the contact areas forming the instant center of rotation 22 are different in absolute value.

The third contact angle 29 of the third contact area 21, which only supports the roller body 13 against the rotation around the instant center of rotation 22, is smaller than the contact angles 27, 28 of the contact areas 19, 20 forming the instant center of rotation 22. The third contact angle 29 of this third contact area 21 is approximately 5 angular degrees.

FIG. 20 shows a detail of a cross-section of a fourteenth design variant of a tripod joint 1. Reference is made to the explanations relating to FIG. 12.

In contrast to the sixth design variant, the contact angles 27, 28 of the contact areas 19, 20 forming the instant center of rotation 22 are different in absolute value.

As in the sixth design variant, but unlike, for example, the thirteenth design variant, the third contact angle 29 of the third contact area 21 is zero angular degrees.

FIG. 21 shows a detail of a cross-section of a fifteenth design variant of a tripod joint 1. Reference is made to the explanations relating to FIG. 19.

In contrast to the thirteenth design variant, the shapes of the second segments 16 of the raceways 17, 18 run rectilinearly and inclined to each other in the cross-section and thus closing towards the second longitudinal axis 9.

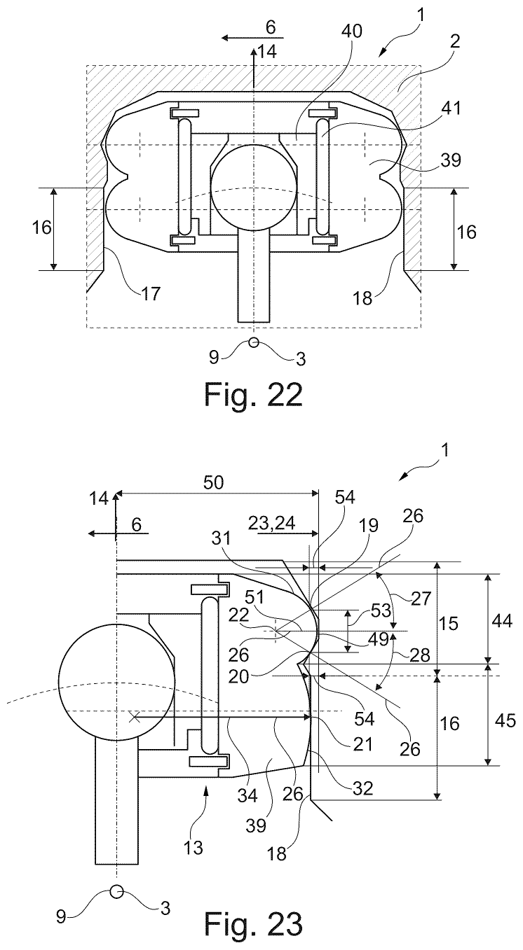

FIG. 22 shows a detail of a cross-section of a sixteenth design variant of a tripod joint 1. Reference is made to the explanations regarding FIGS. 19 and 21.

In contrast to the thirteenth and fifteenth embodiments, the shapes of the second segments 16 of the raceways 17, 18 in the cross-section are rectilinear and parallel to one another and, in an extended state of the tripod joint, inclined with respect to the axis of rotation 14 or trunnion axis 12.

FIG. 23 shows a detail of a cross-section of a seventeenth embodiment of a tripod joint 1. Reference is made to the explanations relating to FIGS. 1 to 7.

The raceway 17, 18 has a Gothic shape (i.e. it is constructed as a pointed arch from two circular arcs) in the first segment 15, which contacts the contact areas 19, 20, 49 or has the contact areas 19, 20, 49, in a cross-section extending transversely to the first longitudinal axis 3. Between the circular arcs, the raceway 17, 18 has a rectilinear shape that differs from the Gothic shape.

In the first segment 15, more than two contact areas 19, 20 are provided. The further fourth contact area 49 is arranged along the radial direction 37 between the first contact area 19 and the second contact area 20. A surface normal 26 of the fourth contact area 49 extends through the instant center of rotation 22.

In intended operation of the multipod joint 1, each roller body 13 contacts the respective recess 7 at any one time only via the majority of the contact areas 19, 20, 21, 50, that is to say only via the first, second, third and fourth contact areas 19, 20, 21, 50 on the respective one raceway 17, 18.

The raceways 17, 18 and the roller body 13 are designed such that, in the case of an extended arrangement of the tripod joint 1, i.e. when the longitudinal axes 3, 9 are aligned coaxially with one another (the angle of inclination 52 then amounts to zero angular degrees), the contact areas 19, 20, 21 are arranged at a respective distance 23, 24, 25 from the trunnion axis 12, wherein the distances 23, 24, 25 deviate from one another by at most 1% of the smallest (first, second, third) distance. The fourth distance 50 of the fourth contact area 49 has a greater deviation from the other distances 23, 24, 25. The fourth distance 50 of the fourth contact area 49 is greater than the distances 23, 24, 25 of the other contact areas 19, 20, 21.

A fourth contact angle 51 of the fourth contact area 49 is smaller than the contact angles 27, 28 of the first contact area 19 and the second contact area 20. The fourth contact angle 51 is equal to zero angular degrees.

In the second segment 16, which contacts the third contact area 21, which only supports the roller body 13 against the rotation about the instant center of rotation 22, the raceway 17, 18 has a rectilinear and mutually parallel shape, in a cross-section extending transversely to the first longitudinal axis 3.

In a cross-section encompassing the axis of rotation 14, the roller body 13 has, in a first region 44, a first contour 31 of an outer circumferential surface encompassing the contact areas 19, 20, 49, and, in a second region 45, a second contour 32 of the outer circumferential surface encompassing a third contact area 21. The first contour 31 is formed by a first radius 33 (that is spherical) and the second contour 32 by a second radius 34 (that is elliptical). The radii 33, 34 are designed differently from one another, with the second radius 34 being larger than the first radius 33.

The first contour 31 and the shape of the raceway 17 are designed such that there is a specific relationship between a distance 53 and a difference 54 of the distances 23, 24, 50. The ratio is formed by the distance 53 (or its unsigned absolute value), which is parallel to the axis of rotation 14, between the first contact area 19 and the second contact area 20, and the difference 54 (or its unsigned absolute value) between the smaller of the first distance 23 and the second distance 24 on the hand and the fourth distance 50 on the and other hand; i.e. the ratio=distance 53/difference 54. The ratio is more than 1.5.

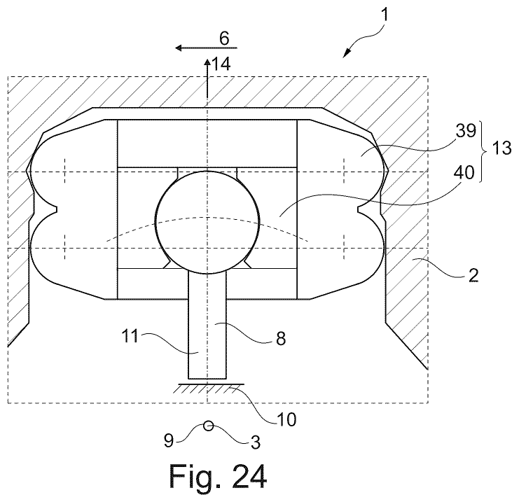

FIG. 24 shows a detail of a cross-section of a multipod joint 1 designed as a bipod joint 1. Reference is made to the explanations relating to FIGS. 1 to 23. The trunnion 11, which has a spherical sliding surface, is arranged in an inner ring 40 that has spherical contact surfaces. The inner ring 40 can slide freely along the axis of rotation 14 in relation to the outer ring 39.

Unlike all the other design variants, the roller body 13 comprises only an outer ring 39 and an inner ring 40. The bearing bodies 41 provided for in the other design variants are not present, so that the inner ring 40 is rotatably mounted directly on the outer ring 39. However, this design without bearing bodies 41 can also be implemented in other multipod joints 1 (e.g. tripod joints).

FIG. 25 shows a tripod joint 1 according to the second embodiment in a side view in a section, in a motor vehicle 38 (indicated). FIG. 26 shows the tripod joint 1 according to FIG. 26 in a deflected state.

The tripod joint 1 comprises an outer joint part 2 having a first longitudinal axis 3 and a cavity 4, which runs parallel to the first longitudinal axis 3 and has an open end 5, wherein three recesses 7 running parallel to the first longitudinal axis 3 are formed in the outer joint part 2, distributed along a circumferential direction 6 extending around the first longitudinal axis 3. The tripod joint 1 further comprises an inner joint part 8 having a second longitudinal axis 9. The inner joint part 8 comprises a central body 10, on which three trunnions 11 are formed, having trunnion axes 12 extending radially from the second longitudinal axis 9, wherein a roller body 13, which is rotatable at least about the trunnion axis 12, is arranged on each trunnion 11.

Each roller body 13 extends in the shape of a ring around an axis of rotation 14 of the roller body 13.

Each roller body 13 is accommodated in a recess 7 so as to be movable along the first longitudinal axis 3. Each recess 7 has two raceways 17, 18 lying opposite one another in the circumferential direction 6.

The roller body 13 comprises an outer ring 39 and an inner ring 40, which can rotate relative to one another. For this purpose, bearing bodies 41 (rolling elements, here needle-shaped rolling elements) are arranged between the inner ring 40 and the outer ring 39. These bearing bodies 41 are arranged in a mounting space of the outer ring 39, the mounting space being limited with respect to the direction of the axis of rotation 14 by retaining rings 46. A plurality of these bearing bodies 41 are arranged along the circumferential direction 6 around the axis of rotation 14. The bearing bodies 41 are secured against displacement along the axis of rotation 14 by the retaining rings 46, which are arranged in a respective groove on the outer ring 39.

The inner joint part 8 can be displaced along the first longitudinal axis 3 relative to the outer joint part 2 and can be deflected by a deflection angle 52 relative to the outer joint part 2 (see FIG. 26). The deflection angle 52 is the smallest angle between the first longitudinal axis 3 and the second longitudinal axis 9. When the joint 1 is in an extended state, the deflection angle 52 is zero angular degrees (see FIG. 25). When the joint 1 is in a deflected state, the deflection angle 52 is more than zero angular degrees (see FIG. 26).

1. A multipod joint having an outer joint part with a first longitudinal axis and a cavity which runs parallel to the first longitudinal axis and which has an open end, wherein at least two recesses running parallel to the first longitudinal axis are distributed along a circumferential direction, which extends around the first longitudinal axis, and a joint inner part with a second longitudinal axis, comprising at least one central body on which at least two trunnions are formed with trunnion axes extending radially from the second longitudinal axis, wherein a roller body rotatable at least about the trunnion axis is arranged on each trunnion, each roller body extending in the shape of a ring around an axis of rotation of the roller body; each roller body being accommodated in each of the recesses in such a way as to be movable along the first longitudinal axis; each recess having two raceways lying opposite one another in the circumferential direction, and each raceway having a first segment and a second segment along a radial direction, which runs transversely to the first longitudinal axis, wherein, when a torque directed in the circumferential direction is transmitted, the roller body is supported relative to the circumferential direction via a plurality of contact areas on one of the two raceways, wherein only via contact areas in the first segment is an instant center of rotation formed for the roller body and at least one contact area in the second segment only supports the roller body against a rotation about the instant center of rotation.

2. The multipod joint according to claim 1, wherein the roller body is supported by the raceway via exactly three contact areas, wherein the instant center of rotation is formed only by a first contact area and a second contact area, which are arranged in the first segment, wherein a third contact area arranged in the second segment only supports the roller body against a rotation about the instant center of rotation.

3. The multipod joint according to claim 1, wherein in an intended operation of the multipod joint each roller body is in contact at any one time with the respective recess only via the majority of the contact areas on the respective one raceway.

4. The multipod joint according to claim 1, wherein the raceways and the roller body are designed such that, in an extended arrangement of the multipod joint, that is to say when the longitudinal axes are aligned coaxially with one another, the contact areas are arranged at a respective distance from the trunnion axis, wherein the distances differ from one another by at most 10% of the smallest distance.

5. The multipod joint according to claim 1, wherein the raceways and the roller body are designed such that, in an extended arrangement of the multipod joint, that is to say when the longitudinal axes are aligned coaxially with one another, and in a cross-section extending transversely to the longitudinal axes, at each contact area a surface normal to the surface of the roller body has a contact angle between the surface normal and a tangential direction (30); wherein a contact angle of the contact areas forming the instant center of rotation is at least five angular degrees in each case.

6. The multipod joint according to claim 5, wherein the contact angles of the contact areas forming the instant center of rotation are respectively equal in absolute value or different in absolute value.

7. The multipod joint according to claim 5, wherein the contact angle of the contact area which only supports the roller body against a rotation about the instant center of rotation is smaller than the contact angles of the contact areas.

8. The multipod joint according to claim 5, wherein the contact angle of the contact area which only supports the roller body against a rotation about the instant center of rotation has an absolute value of less than 10 angular degrees.

9. The multipod joint according to claim 1, wherein the first segment of the raceway that makes contact with the contact areas forming the instant center of rotation for the roller body has a Gothic shape in a cross-section extending transversely to the first longitudinal axis.

10. The multipod joint according to claim 1, wherein the second segment of the recess, which contacts the contact area that only supports the rotation of the roller body about the instant center of rotation, has a straight, concave or convex shape in a cross-section extending transversely to the first longitudinal axis.

11. The multipod joint according to claim 1, wherein the roller body in a cross-section encompassing the axis of rotation has in a first region a first contour of an outer circumferential surface encompassing the contact areas and in a second region has a comprising at least one contact area, a second contour of the outer circumferential surface; the first contour being formed by at least one first radius and the second contour being formed by at least one second radius, the radii being different or the same size.

12. The multipod joint according to claim 11, wherein the second radius is greater than the first radius.

13. The multipod joint according to claim 11, wherein the radii are the same size and the raceways of a recess which are contacted by the roller body, are designed differently from one another, so that the arrangement of the first segment and of the second segment in the raceways is different.

14. The multipod joint according to claim 1, wherein a PCR1 of the inner joint part and a PCR2 of the outer joint part are arranged along the radial direction between the instant center of rotation and the third contact area; wherein the PCR is the pitch circle radius.

15. A motor vehicle having at least one multipod joint according to claim 1.
